(19) United States
(12) Patent Application Publication
(10) Pub. No.: US 2007/0096412 A1
(43) Pub. Date: May 3, 2007

(54) Portable air compressor dolly with retractable handle

(75) Inventor: Tom Sharp, Jackson, TN (US)

Correspondence Address: GREER, BURNS & CRAIN, 300 S WACKER DR, 25TH FLOOR, CHICAGO, IL, 60606, US

(73) Assignee: MIDWEST AIR TECHNOLOGIES, INC.

(21) Appl. No.: 11/262,015

(22) Filed: Oct. 27, 2005

(51) Int. Cl. B62B 1/00

(52) U.S. Cl. 280/47.24

(57) ABSTRACT

A retractable handle on a dolly for a portable compressor has a handle assembly including at least one handle pole and a handle grip member. The handle assembly is clamped onto a frame of the dolly using a clamp assembly. The clamp assembly includes a bearing portion configured for mounting the clamp assembly onto the frame, and a bushing portion for slidingly engaging the handle pole with respect to the clamp assembly.

### BACKGROUND OF THE INVENTION

The present invention relates generally to equipment dollies used with portable air compressors, and more particularly, to a handle for such a dolly configured for the support and movement of a portable air compressor, gas tank, or other similar heavy machinery to and from a jobsite.

Air compressors required for use with large pneumatically-powered tools on jobsites, such as power fastener drivers including roofing nailers or paint sparyers, can generally weigh as much as 70 pounds and are very difficult to move over long distances or rough terrain, such as commonly found at construction sites. Moving the compressor or gas tank is physically demanding to the workers.

Another problem with moving portable compressors and gas tanks is that they can be damaged, such as when they are dropped, or when they are carried by or on equipment not designed to bear the weight of the compressor. Further, particular care must be taken to prevent damage when transporting tanks containing compressed air, fuel, volatile gases or other contents.

To address this problem, a dolly can be used to transport compressors with a measure of maneuverability over difficult terrain. For added maneuverability, a handle is commonly provided and extends generally perpendicularly from the dolly platform to a height which is comfortable to the average user. This height is generally above the waist but below the shoulders of the user. However, when a conventional handle is added to the dolly, the height of the dolly is increased and the portable air compressor and the dolly are not easily stored in restricted spaces. On the other hand, if the height of the handle is decreased, it is difficult for the user to maneuver the dolly, particularly over difficult terrain.

Accordingly, there is a need for a dolly for an air compressor or the like with a handle that is storable in restricted spaces, yet is comfortable and maneuverable by the user.

### SUMMARY OF THE INVENTION

The above-listed needs are met or exceeded by the present retractable handle on a dolly for a portable compressor, which has a handle assembly including at least one handle pole and a handle grip member. A clamp assembly secures the handle assembly onto a frame of the dolly. The clamp assembly includes a bearing portion configured for mounting the clamp assembly onto the frame, and a bushing portion for slidingly engaging the handle pole to permit the pole to extend and retract with respect to the clamp assembly.

A clamp assembly for use on a dolly having a frame and a retractable handle is also provided. The clamp assembly has a bearing portion having a contact surface configured for mounting the clamp assembly on the frame of the dolly. The clamp assembly also has a bushing portion having an opening configured for slidingly engaging the retractable handle with respect to the clamp assembly. A fastener recess is located between the contact surface of the bearing portion and the opening of the bushing portion. On an opposite wall of the bushing portion to the fastener recess is an access orifice.

Further, a method of attaching a bearing portion to a faceplate and a frame of a dolly for a portable compressor is provided. The method includes the steps of providing the bearing portion, which has a contact surface configured for receiving the frame and a fastener recess, and also providing the faceplate, which has a receiving portion configured for receiving the frame and a boss having an internally threaded portion. Additionally, an aperture on the frame is also provided. The boss is inserted into the aperture, and the fastener recess is also aligned with the aperture opposite the faceplate. The fastener is threaded through the fastener recess and into the aperture, and the internally threaded boss captures the fastener.

### BRIEF DESCRIPTION OF THE DRAWINGS

FIG. 1 is an exploded front perspective view of a dolly, a faceplate, a handle, a plurality of clamp assemblies and a compressor (in phantom) of the present invention;

FIG. 2 is a top view of the dolly of FIG. 1;

FIG. 3 is a front view of the dolly of FIG. 1;

FIG. 4 is a right side view of the dolly of FIG. 1;

FIG. 5 is a top view of the bearing of FIG. 1;

FIG. 6 is a top view of the bearing of FIG. 1 with a section view of a dolly arm and a partial top view of the faceplate;

FIG. 7 is a section view of the bearing along section A-A of FIG. 6 with a fastener inserted and engaged with the faceplate, the dolly arm (in phantom), an assembly view of a handle pole, and a screwdriver inserted into the bearing (in phantom);

FIG. 8 is a top view of the faceplate of FIG. 1;

FIG. 9 is a front view of the faceplate of FIG. 1;

FIG. 10 is a right side view of the faceplate of FIG. 1;

FIG. 11 is a rear view of the faceplate of FIG. 1;

FIG. 12 is a top view of the handle of FIG. 1;

FIG. 13 is a front view of the handle of FIG. 1;

FIG. 14 is a schematic of a spring-clip lock of the handle of FIG. 1;

FIG. 15 is a partial front view of the handle of FIG. 1; and

FIG. 16 is a partial side view of the handle of FIG. 1.

### DETAILED DESCRIPTION

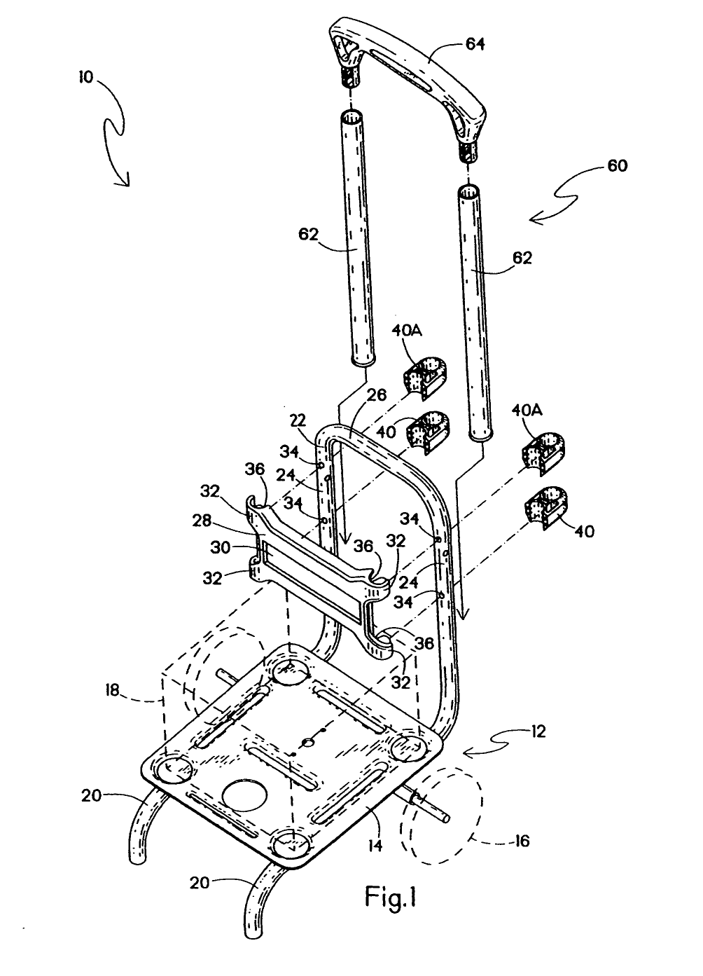

Now referring to FIG. 1, a dolly for a portable air compressor incorporating the features of the present invention is generally designated 10 and includes a frame generally designated 12, a platform 14, and at least one, but preferably two wheels 16 (shown in phantom). The platform 14 of the dolly is configured to receive a compressor tank 18 (shown in phantom). As is known in the art, the compressor tank 18 may be oriented on the platform 14 in a generally vertical or generally horizontal orientation. An exemplary dolly is disclosed in commonly owned U.S. patent Ser. No. 10/680,547, entitled “Dolly for Portable Air Compressor”, which is incorporated by reference herein.

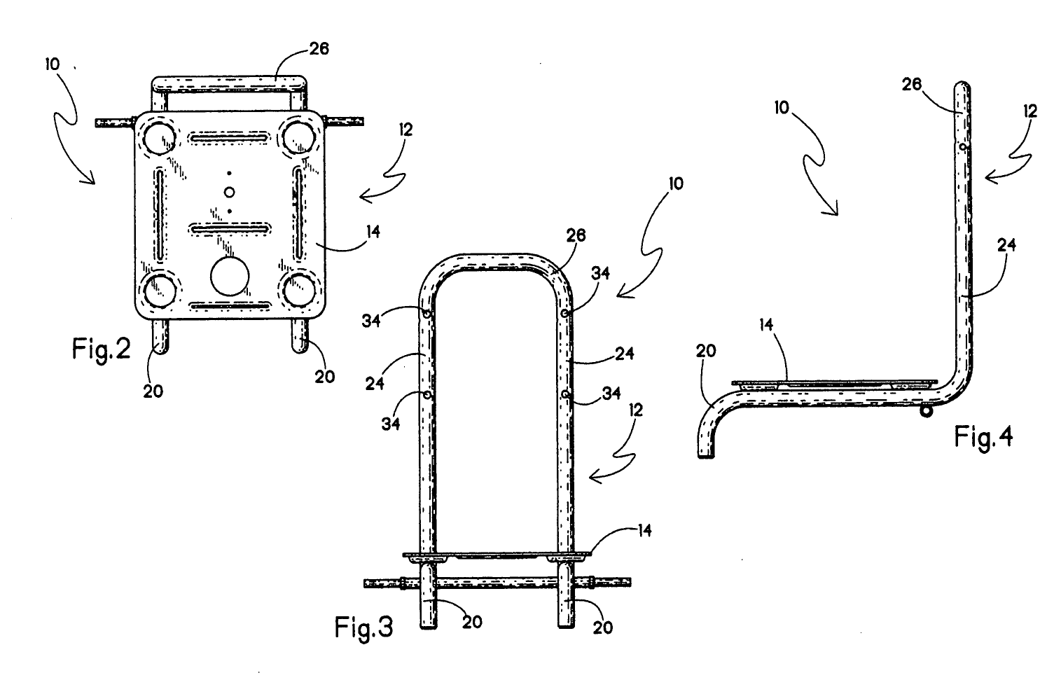

Referring now to FIGS. 1-4, the dolly 10 will be described in more detail. Preferably integrally formed, or alternatively formed as separate members, the frame 12 has two legs 20 and an inverted “U”-shaped frame handle structure 22. The frame handle structure 22 has arms 24 and a cross bar 26 which form the inverted “U” shape, although other shapes and configurations are contemplated. The arms 24 are spaced a distance apart to allow the compressor, gas tank, fuel tank or any other large article 18, to occupy the space between the arms. The spacing distance may vary to suit the application.

In the preferred embodiment, the frame handle structure 22 is constructed of a single piece of strong, rigid and durable material such as tubular steel that is formed into a “U”-shape. In an alternate embodiment, the frame handle structure 22 is constructed of multiple components. Further, a protective coating may be applied to both the frame 12 and the frame handle structure 22.

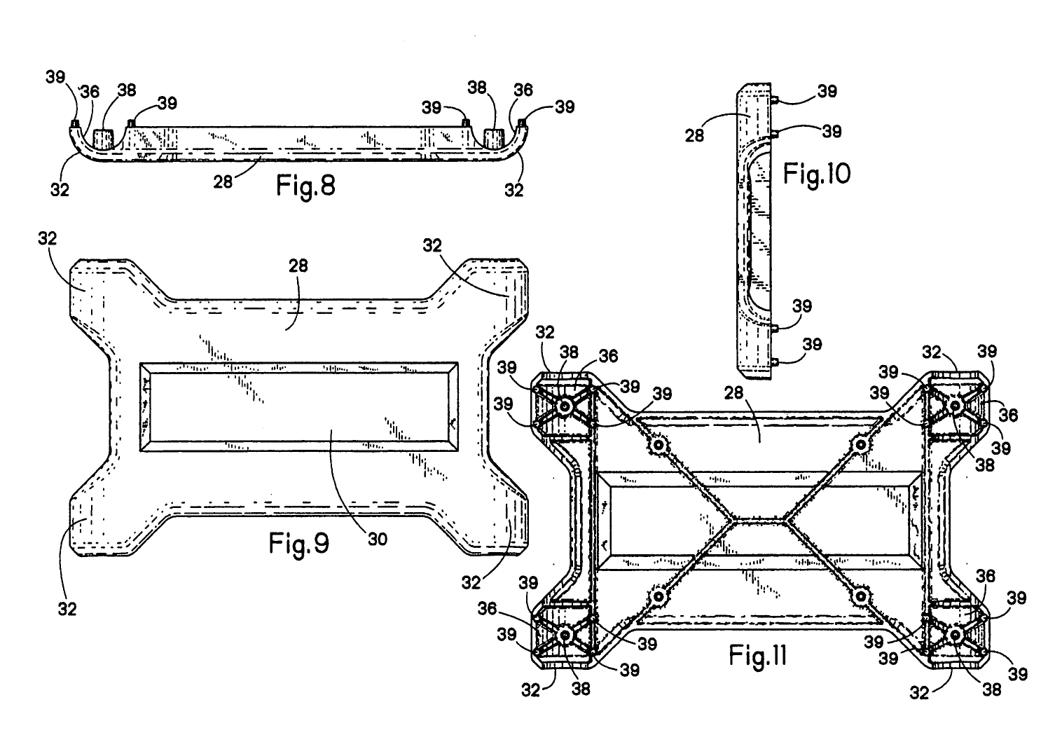

Referring now to FIGS. 1 and 8-11, extending from one arm 24 to the other arm is a faceplate 28. While other durable materials are contemplated, the faceplate 28 is preferably die cast aluminum or injection molded plastic, and preferably has a marking portion 30 for displaying information about the compressor 18, or any other information. The faceplate 28 may also serve to support portions of the compressor 18 when the dolly 10 is inclined backwards.

The faceplate 28 preferably has four receiving portions 32 for engaging the arms 24 of the frame handle structure 22 at four corresponding apertures 34. While the preferred embodiment has four receiving portions 32 and four apertures 34, it is appreciated that the number and arrangement may vary. The receiving portions 32 have a generally semi-circular contact surface 36 that is configured to receive the generally circular cross-sectional shape of the arms 24. However, it is contemplated that other shapes of contact surfaces 36 and arms 24 may be used. Further, it is contemplated that individual receiving portions 32 can be used instead of a common faceplate 28 connecting the portions.

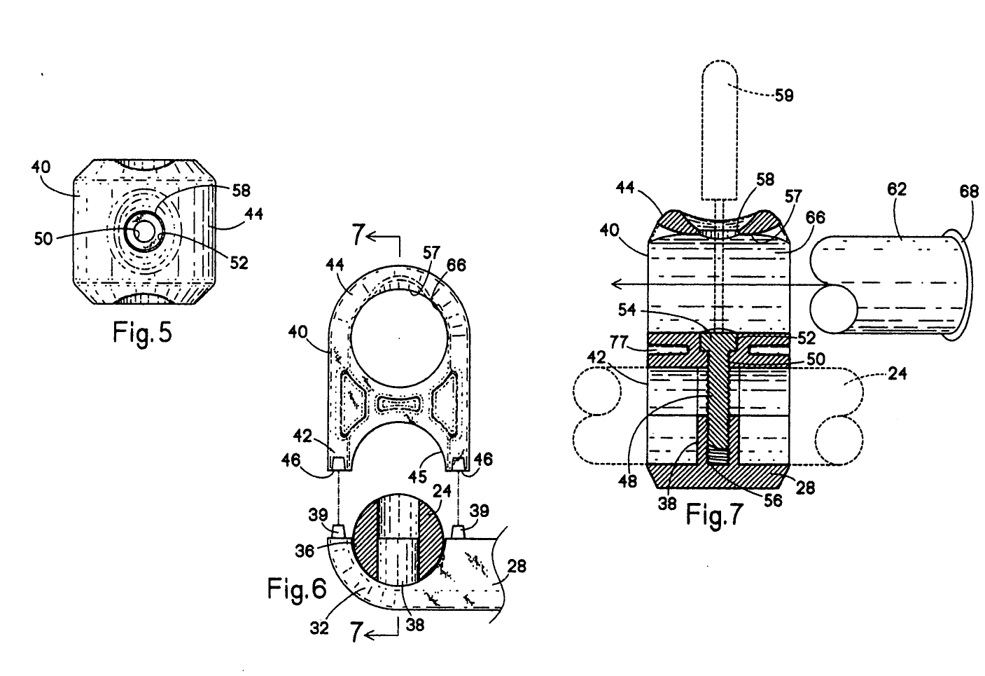

Turning now to FIGS. 1 and 5-11, the connection of the receiving portions 32 to the arms 24 of the frame handle structure 22 will be described. At each of the receiving portions 32, the faceplate 28 has a primary boss 38 located generally centrally at the semi-circular shape and protruding therefrom. As seen in FIG. 6, the primary boss 38 is configured to be inserted into the aperture 34 of the arm 24 to self-locate the receiving portion 32 in position relative to the arm. Further, the semi-circular contact surface 36 is configured to contact the arm 24 of the frame 12 in a substantially flush engagement. The receiving portions 32 preferably also have at least one, but preferably a plurality of secondary bosses 39 at each end of the semi-circular contact portion 36, as will be described in more detail, below.

A clamp assembly 40 forms a clamp with the receiving portion 32 around the arm 24. In the preferred embodiment, when viewed from above (FIG. 6), the clamp assembly 40 has a figure “8” shape, where a portion of the bottom ring of the “8” shape is removed, but is completed by the receiving portion 32. The clamp assembly 40 includes a bearing portion 42 (open ring) and a bushing portion 44 (closed ring). In other embodiments, the bearing portion 42 may be a closed ring, or may be any other shape that permits it to act as a bearing. Similarly, the bushing portion 44 may be an open ring, or may be any other shape that permits it to act as a bushing.

Preferably, the bearing portion 42 has a generally semi-circular contact surface 45, and a recess 46 located at each side of the contact surface. The bearing portion 42 preferably engages the faceplate 28, preferably by receiving the secondary bosses 39 into the recesses 46 in a pressure fit, as seen in FIG. 6. In the preferred engaged position, the contact surface 36 of the faceplate 28 and the contact surface 45 of the bearing portion 42 concentrically encircle the arm 24.

Additionally, as seen in FIG. 7, a threaded fastener 48 is introduced through a fastener recess 50 located between the contact surface 45 of the bearing portion 42 and the bushing portion 44. The fastener recess 50 preferably includes a recessed seat 52 for seating the head 54 of the fastener to prevent protrusion into the bushing portion 44. The fastener 48 extends into the aperture 34 of the arm 24, and is captured in an inside surface 56 of the boss 38. Located inside the aperture 34 of the arm 24, the boss 38 is internally threaded to receive the threaded fastener 48.

To capture the fastener 48 in the boss 38, the fastener is preferably introduced through an access orifice 58 located in the bushing portion 44 on a wall 57 opposite to and aligned with the fastener recess 50. For ease of insertion, the access orifice 58 is preferably in registry with the recessed seat 52. When the fastener 48 is located in the fastener recess 50, a screwdriver or other tool 59 (shown in phantom) is inserted through the access orifice 58 to thread the fastener until the head 54 is seated in the recessed seat 52. In this configuration, the receiving portion 32 and the bearing portion 42 are attached to each other, and the clamp assembly 40 is anchored to the frame handle structure 22.

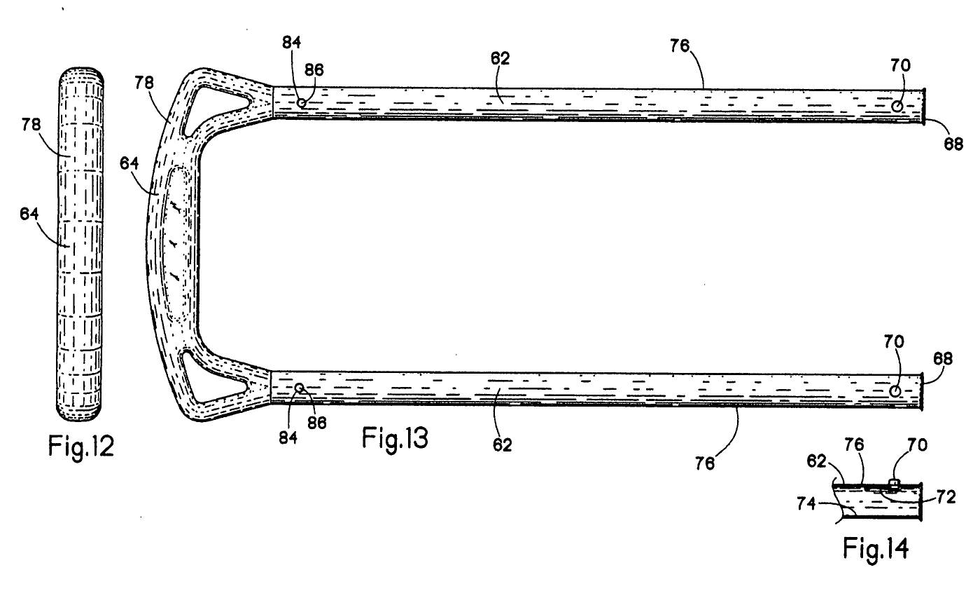

Referring now to FIGS. 1, 5-7 and 12-14, the handle assembly 60 extends from the clamp assembly 40 and has generally parallel alignment with the frame handle structure 22. The handle assembly 60 includes at least one, but preferably two handle poles 62 and at least one handle grip member 64 extending between the poles to form a general “U”-shape.

Disposed inside an opening 66 in the bushing portion 44 of the clamp assembly 40, the handle assembly 60 is configured to slidingly extend and retract with respect to the frame 12. In a retracted position, the handle poles 62 are slid downward in the opening 66 towards the platform 14 of the frame 12, and generally parallel with and adjacent to the arms 24. The handle assembly 60 is fully retracted when the handle grip member 64 engages the bushing portion 44 of an upper clamp assembly 40A. Alternatively, it is contemplated that a stop can be located on the pole 62. In the retracted position, the overall height of the dolly is decreased, making storage of the portable air compressor feasible in restricted spaces.

In an extended position, the handle poles 62 are slid upward away in the opening 66 from the platform 14 of the frame 12. The handle poles 62 are extendable to a height that is comfortable to the user, generally somewhere between waist and shoulder height of the user. A flared end 68 is provided on the poles 62 to prevent the poles from pulling out of the bushing portion 44. The flared end 68 is sized to be larger than the opening 66 to prevent pole pull-out, however other stops may be incorporated.

To hold the handle poles 62 in an extended position relative to the clamp assembly 40, at least one spring-loaded button 70 is located on the pole. A spring 72 located inside the handle pole 62 biases the button 70 to protrude from an inside surface 74 to an outside surface 76 of the pole. In this way, the button 70 forms a stop to impede the sliding motion of the handle pole 62 within the opening 66 by engaging an upper surface of the bushing portion 44 on the uppermost clamp assembly 40A.

To retract the handle pole 62, the user overcomes the bias of the spring 72 by pressing the button 70 and selectively sliding the pole within the opening 66. While the preferred embodiment has one spring-loaded button 70 on each pole 62, it is contemplated that a plurality of buttons can be located on the poles for varying lengths of extension and retraction. Further, other means of selectively locking the poles 62 into varying lengths of extension and retraction are contemplated.

The clamp assembly 40 is disposed in spaced relationship on the arms 24. Further, the clamp assembly 40 is designed and constructed of suitable materials to support the static and dynamic loading of the compressor and dolly without major deformation of the clamp assembly during use. Further, the contouring and removal of portions of the clamp assembly 40 not necessary for maintaining the requisite strength of the assembly, such as removal portion 77, reduces the amount of material used, thus lessening costs. Further, the bearing portion 42 and the bushing portion 44 are preferably integrally formed to create the clamp assembly 40, however it is contemplated that the portions may be formed in components and attached to each other.

It is preferable that the contact surface 45 of the bearing portion 42 and the opening 66 of the bushing portion 44 are configured to receive members, preferably the frame handle structure 22 and the handle poles 62, respectively, which are substantially parallel. Additionally, while the bushing portion 44 is preferably an enclosed sleeve, it is contemplated that the bushing portion can be an open sleeve, a notch-in-groove arrangement with the pole, or any other arrangement which permits the sliding engagement of the pole.

Turning now to FIGS. 1 and 12-16, the handle grip member 64 is attached to the poles 62 to form the handle assembly 60. The handle grip member 64 includes a hand receiving portion 78 for receiving the hands of the user, and a pole-engaging portion 80 for engaging the poles 62. The pole-engaging portion 80 is sized and shaped to be slightly smaller than the inside dimensions of the pole 62. In this way, the pole-engaging portion 80 is configured to be pressure-fit inside the pole 62′. Further, a nut 82, or similar mechanical receiving structure, is captured or located in the pole-engaging portion 80.

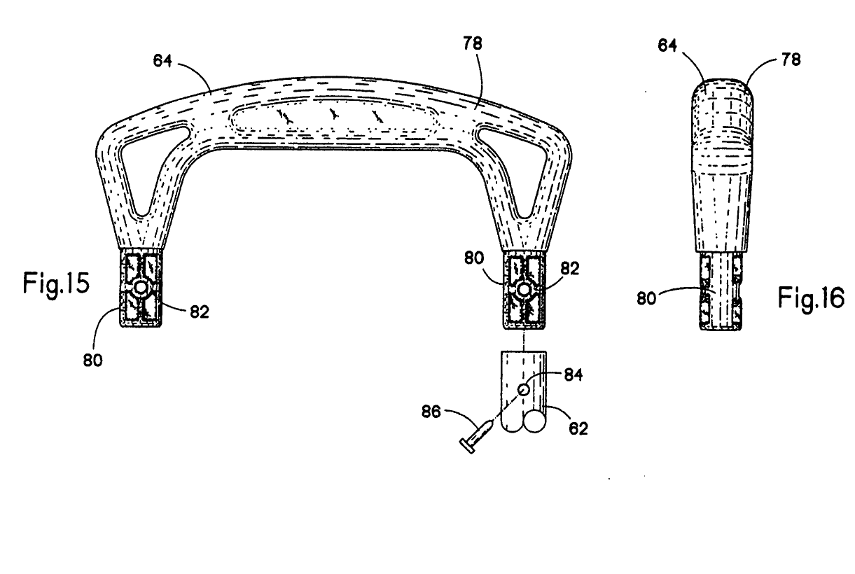

When the pole-engaging portion 80 is assembled onto the pole 62, the nut 82 is moved into registry with an upper aperture 84 on the pole. Subsequently, an upper fastener 86 is inserted into the upper aperture 84 and received in the captured nut 82, as seen in FIG. 15. The engagement of the handle grip member 64 and the pole 62 is not only strong, but it also saves material, thus lowering cost, and minimizes the outside appearance of fasteners on the handle assembly 60.

While particular embodiments of the present portable air compressor dolly with retractable handle have been shown and described, it will be appreciated by those in the art that changes and modifications may be made thereto without departing from the invention in its broader aspects and as set forth in the following claims.

I claim:

1. A retractable handle on a dolly for a portable compressor, the dolly having a frame, said retractable handle comprising:
a handle assembly including at least one handle pole and at least one handle grip member,
a clamp assembly for clamping said handle assembly onto the frame includes a bearing portion and a bushing portion, said bearing portion configured for mounting said clamp assembly on the frame of the dolly, and said bushing portion configured for slidingly engaging said at least one handle pole to permit the pole to extend and retract with respect to said clamp assembly.

2. The retractable handle of claim 1 wherein said at least one handle pole has a flared end that is configured to impede the sliding motion of the handle pole through said bushing portion.

3. The retractable handle of claim 1 wherein said at least one handle pole extends and retracts generally parallel to an arm of the frame.

4. The retractable handle of claim 1 further comprising a stop member for maintaining said at least one handle pole in an extended position relative to the clamp assembly.

5. The retractable handle of claim 4 wherein said stop member comprises a button having a spring that biases said button to protrude from an outside surface of said pole, said button configured to engage the clamp assembly to impede sliding of said pole in one direction, wherein the bias of said spring can be overcome by the user to permit said pole to slide in said one direction.

6. The retractable handle of claim 1 wherein said bushing portion defines an opening in which said at least one pole member is slidingly disposed.

7. The retractable handle of claim 1 wherein said handle grip member has a pole-engaging portion configured for engaging said handle pole, said pole-engaging portion being dimensioned to be disposed inside said handle pole.

8. The retractable handle of claim 7 wherein said pole-engaging portion includes a mechanical receiving structure captured in said pole-engaging portion, and said handle pole includes an aperture configured to be located in registry with said mechanical receiving structure when said pole-engaging portion is disposed inside said handle pole, wherein a fastener is configured to be introduced in said aperture and received in said mechanical receiving structure.

9. The retractable handle of claim 8 wherein said mechanical receiving structure is a nut.

10. A clamp assembly for use on a dolly having a frame and a retractable handle, said clamp assembly comprising:
a bearing portion having a contact surface configured for mounting the clamp assembly on the frame of the dolly;
a bushing portion having an opening configured for slidingly engaging the retractable handle with respect to the clamp assembly;
a fastener recess located between said contact surface of said bearing portion and said opening of said bushing portion; and
an access orifice located on an opposite wall of said bushing portion to said fastener recess.

11. The clamp assembly of claim 10 wherein said fastener recess includes a recessed seat configured for seating a head of a fastener.

12. The clamp assembly of claim 10 wherein said access orifice is in registry with said fastener recess and configured to accommodate the introduction of a tool to thread a fastener in said fastener recess.

13. The clamp assembly of claim 10 wherein said clamp assembly is integrally formed.

14. The clamp assembly of claim 10 wherein said contact surface of said bearing portion is substantially semi-circular and said opening of said bushing portion is circular.

15. The clamp assembly of claim 10 wherein said contact surface of said bearing portion and said opening of said bushing portion are configured to receive members that are substantially parallel.

16. A method of attaching a bearing portion to a faceplate and a frame of a dolly for a portable compressor, said method comprising:
providing the bearing portion having a contact surface configured for receiving the frame, said bearing portion including a fastener recess;
providing the faceplate having a receiving portion configured for receiving the frame, said receiving portion including a boss having an internally threaded portion;
providing the frame having an aperture through the frame;
inserting said boss into said aperture;
aligning said fastener recess of the bearing portion with said aperture of the frame opposite of the faceplate;
threading a fastener through the fastener recess of the bearing portion, into said aperture; and
capturing said fastener in said internally threaded portion of said boss.

17. The method of claim 16 further comprising the steps of:
providing at least one secondary boss on one of the bearing portion and the faceplate;
providing at least one recess on the other of the bearing portion and the faceplate;
engaging said at least one secondary boss with said at least one recess.

18. The method of claim 16 further comprising the steps of:
providing a bushing portion attached to or integrally formed with the bearing portion, said bushing portion including an opening, said fastener recess located between said contact surface of the bearing portion and said opening of said bushing portion;
providing an access orifice located on an opposite wall of said bushing portion to said fastener recess; and
introducing a tool through said access orifice to thread said fastener.

19. The method of claim 16 wherein said contact surface of the bearing portion is configured to contact the frame in a substantially flush engagement.

20. The method of claim 16 wherein said fastener recess includes a recessed seat configured for seating a head of said fastener.
